(19) United States
(12) Patent Application Publication
(10) Pub. No.: US 2016/0180441 A1
(43) Pub. Date: Jun. 23, 2016

(54) ITEM PREVIEW IMAGE GENERATION

(71) Applicant: Amazon Technologies, Inc., Seattle, WA (US)

(72) Inventors: Shiblee Imtiaz Hasan, Seattle, WA (US); Joseph Edwin Johnson, Seattle, WA (US); Nathan Eugene Masters, Redmond, WA (US)

(21) Appl. No.: 14/579,417

(22) Filed: Dec. 22, 2014

(51) Int. Cl. G06Q 30/06; G06F 3/0481; G06F 3/0482

(52) U.S. Cl. CPC G06Q 30/0631; G06F 3/0482; G06F 3/04815

(57) ABSTRACT

Augmented reality may be used to preview how an item may be used in conjunction with another item in a particular context. The systems disclosed herein can access an image of a location that includes a reference marker and one or more items. The systems may then identify the items and the size of the location using the reference marker as a guide. A complementary item, such as an organizer, may be selected based on the identified items and the size of the location. This selected organizer may be recommended to the user to help organize the items identified from the image. Further, a preview image can be constructed using an image of the selected organizer and the accessed image of the location to illustrate how the selected organizer may be used at the location with the one or more items depicted in the original image.

### CO-PENDING APPLICATIONS

The present application is filed on the same day as co-pending U.S. application Ser. No. XX/XXX,XXX (Attorney Docket No. SEAZN.1058A1), which is titled “IMAGE-BASED COMPLEMENTARY ITEM SELECTION” and was filed on Dec. 22, 2014, and U.S. application Ser. No. XX/XXX,XXX (Attorney Docket No. SEAZN.1065A), which is titled “IMAGE-BASED ITEM LOCATION IDENTIFICATION” and was filed on Dec. 22, 2014, the disclosures of which are hereby incorporated by reference in their entirety herein.

### BACKGROUND

Various methods are used by retailers (e.g., brick-and-mortar stores and Internet-based stores) in an attempt to sell items (e.g., goods and/or services). Some retailers attempt to use market-based data to promote items. For example, a retailer may identify or recommend to potential customers items that are best-selling or most popular among other customers. Some retailers may identify items that have received positive praise from third-party sources that may appeal to potential customers.

In some cases, retailers attempt to appeal to an individual customer by recommending items based on what other customers may have purchased who bought or viewed similar items. However, the retailer often does not know why the other customers selected the item and so such a recommendation may not be effective with some potential customers. In an attempt to personalize the recommendations, some retailers may recommend items based on similarities between the items and previously purchased items of an individual customer. For instance, a retailer may recommend a movie that is of a similar genre as a movie previously purchased by the customer.

### BRIEF DESCRIPTION OF THE DRAWINGS

Throughout the drawings, reference numbers are re-used to indicate correspondence between referenced elements. The drawings are provided to illustrate embodiments of the inventive subject matter described herein and not to limit the scope thereof.

FIG. 1A is a pictorial diagram illustrating an example of a storage space storing a number of items.

FIG. 1B is a pictorial diagram of a sample preview image illustrating the use of an example organizer item in the storage space of FIG. 1A, which preview page may be generated at least in part by an interactive computing system described herein.

FIG. 2A is a pictorial diagram illustrating a second example of a storage space storing a number of items.

FIG. 2B is a pictorial diagram of a second example of a preview image illustrating the use of an example organizer item in the storage space of FIG. 2A.

FIG. 3 is a block diagram illustrating an embodiment of a networked computing environment for implementing features described herein.

FIG. 4 is a flowchart of an illustrative embodiment of an organizer preview process that may be implemented by an interactive computing system.

FIG. 5 is a flowchart of an embodiment of an item identification process that may be implemented by an interactive computing system.

FIG. 6 is a flowchart of an illustrative embodiment of an organizer selection process that may be implemented by an interactive computing system.

FIG. 7 is a flowchart of an illustrative embodiment of an organizer preview selection process that may be implemented by an interactive computing system.

FIG. 8 is a flowchart of an illustrative embodiment of a preview image generation process that may be implemented by an interactive computing system.

FIG. 9 is pictorial diagram of an illustrative user interface generated by a computing system for selecting an organizer to preview.

### DETAILED DESCRIPTION

### Introduction

Recommending an item based on a similarity between the item and another item purchased or viewed by a customer is often effective. However, such a recommendation typically does not account for interoperability between items. For instance, a recommendation of a shoe rack may be useful for a user who has purchased a number of shoes. However, an over-the-door shoe rack may be less effective for a user who stores the shoes in a location without a door, or a mirrored sliding door. Thus, it can be beneficial to have context information relating to a storage location for the shoes in generating a recommendation.

One value of recommendations from the perspective of a retailer is the rate that the recommendations are converted to sales. A particular user may be hesitant to purchase an item without seeing how the item can be used with other items that the user owns or plans to use in conjunction with the item. Thus, the conversion rate for recommendations may be improved when the recommended items are presented in a particular context. For example, a shoe rack presented with shoes on the shoe rack is more likely to result in a sale than a shoe rack presented in isolation. Moreover, a shoe rack presented to a user illustrating both the user's shoes and the location where the user may place the shoe rack is more likely to result in a sale than presenting a generic image of the shoe rack and shoes that is not specific to the user.

Embodiments of systems and processes described herein can identify complementary items, such as shoe racks or other organizers, to recommend to users who own or otherwise have access to items, such as shoes, that may be used in conjunction with the complementary items. Further, embodiments of systems and processes described herein can present a preview image to a user that illustrates how the complementary item (e.g., a shoe rack) may be used with items (e.g., shoes) of the user in a particular context, such as a closet at the home of the user.

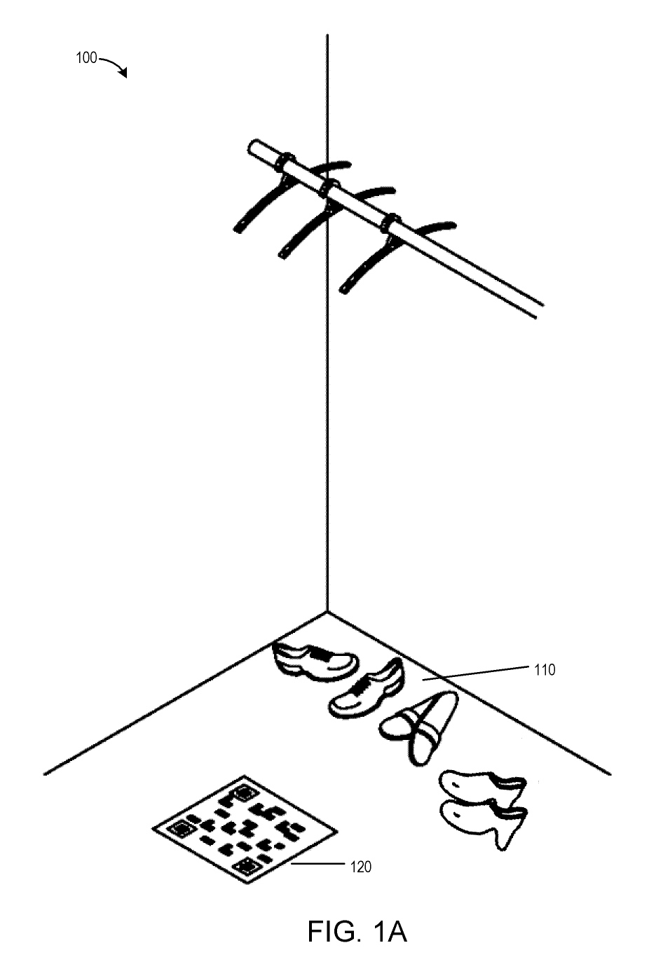

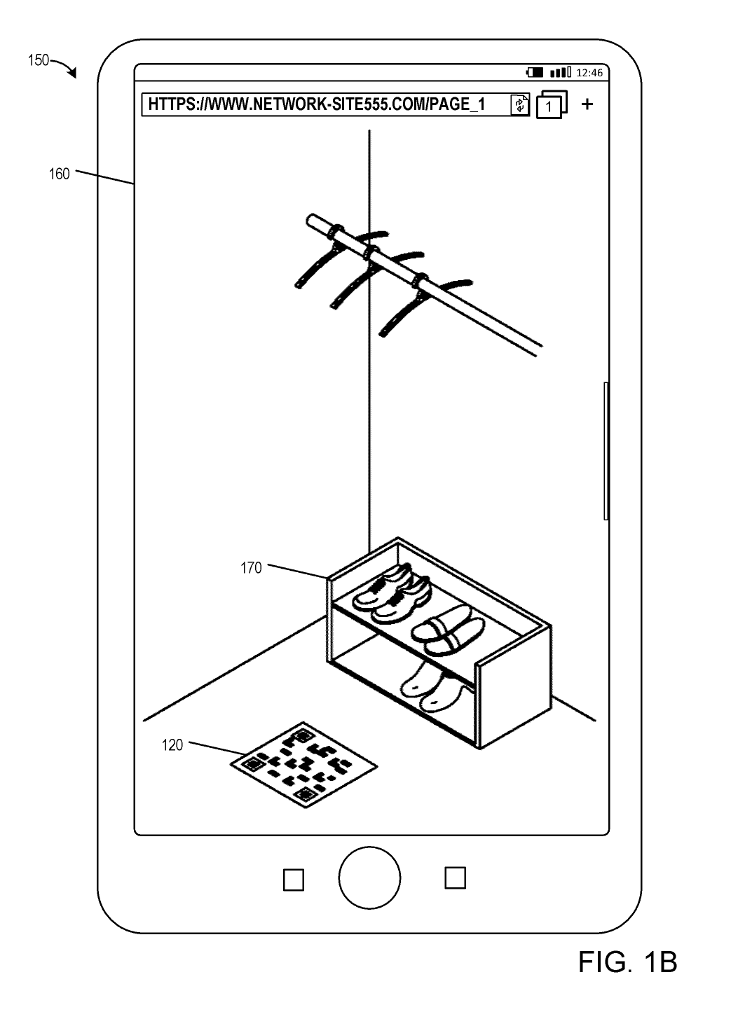

For instance, with reference to FIGS. 1A and 1B, a preview image may be generated that illustrates how the user's flats, or non-high heel shoes, may be positioned on a top rack of a recommended shoe rack, while the user's high heel shoes can be positioned on a bottom rack of the recommended shoe rack. FIG. 1A illustrates a user's closet 100 with a number of shoes 110 and a reference marker 120. The reference marker 120 may be, for example, a physical printout of an image or code that is provided to the user for placement in a location in order to assist an interactive computing system with determining dimensions and other information of objects appearing near the reference marker. A user may use a computing device to capture an image of the closet 100.

FIG. 1B illustrates the user's computing device 150 that displays an image 160 of the user's closet 100. However, instead of displaying the view of the closet 100 as captured by, for example, a video camera of the computing device 150, the display of the computing device 150 displays a modified, or augmented, view of the closet that illustrates a shoe rack 170 with the user's shoes positioned on the shoe rack at the location where the shoes are currently located in the closet. In the illustrated embodiment, the size of the closet is determined using an image of the reference marker 120 as a reference. Thus, the systems described herein can identify items that will fit in the user's intended location. Presenting the preview image 160 using images of the shoes the user owns and illustrating the shoe rack in the context of the user's closet 100 may help improve the effectiveness of the recommendation and reduce the rate of returns for purchased items.

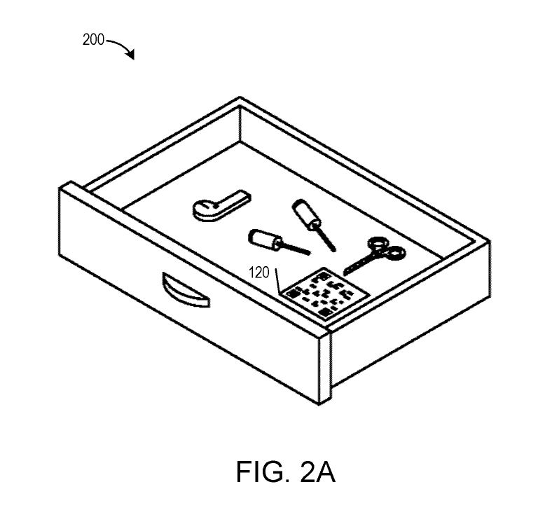

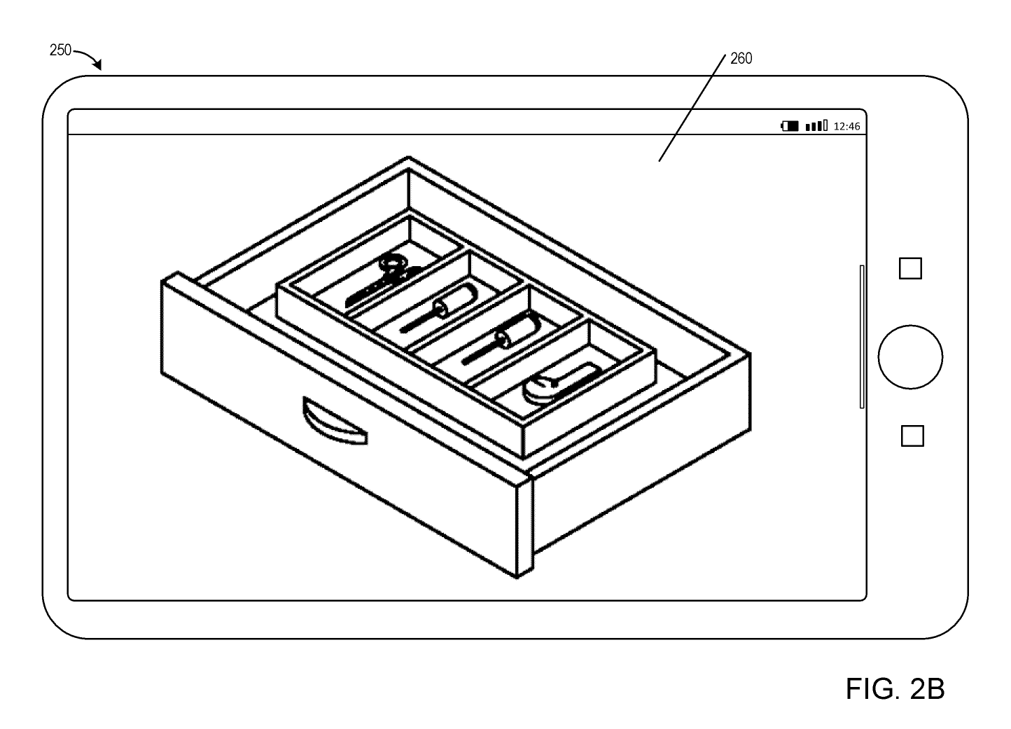

Another example of presenting a preview image of a complementary item to a user is illustrated with respect to FIGS. 2A and 2B. FIG. 2A presents a drawer 200 with a number of tools, such as screwdrivers and scissors. Similar to the closet 100, the drawer 200 may have a reference marker 120, which may be placed in the drawer by a user to facilitate various embodiments disclosed herein. FIG. 2B illustrates a user computing device 250 that displays an image 260 of the drawer 200 with the tools organized in an organizer. As will be discussed below, the image 260 may be generated by an interactive computing system in a number of ways, depending on the embodiment, including two-dimensional or three-dimensional image manipulation and/or rendering. As illustrated in FIG. 2B, the reference marker that is placed in the drawer 200 as illustrated in FIG. 2A may be removed from the image that is displayed to the user on the user computing device 250.

Embodiments of systems and processes described herein may take advantage of augmented reality techniques to present an image of a recommended item to a user in the context of the location where the user desires to use the item and in conjunction with items the user plans to use with the recommended item. Augmented reality may enable a user to view on a screen of a user computing device an image with annotations or additional information. In some cases, an image captured by an optical device (e.g., video camera) of a user computing device can be modified or supplemented and presented to the user on a display of the user computing device with the changes to the captured image. For example, a camera of a smartphone may capture images of a street that a user is walking along. The display of the smartphone may display the captured image of the street and may overlay arrows indicating which direction the user should turn to reach a particular destination.

Embodiments of systems and processes herein may obtain an image of a location, such as a drawer, and a number of items in the drawer, such as a number of office supplies. Further, the image may include at least one item with dimensions known to the system that can serve as a reference marker or object. Using the reference marker, the systems herein can determine a size or spatial characteristics of the drawer, or other location. Further, the systems herein may perform one or more image recognition techniques to identify the office supplies, or other items, in the image and the sizes, dimensions, or other spatial characteristics of the items. In some cases, the systems may use the reference marker to help determine the sizes of the items. Using the size information of the location, and size and type information for the items in the image, systems herein can identify one or more complementary items, such as drawer organizers or office supply organizers to recommend to the user, according to some embodiments. Further, an image can be generated and presented on a display of the user device that illustrates the office supplies organized within the drawer organizer and that illustrates the drawer organizer within the drawer providing a potential customer or other user with a preview of the recommended item that is context-specific.

Embodiments described herein may be used with a variety of complementary items and the present disclosure is not limited to particular types of items. However, to simplify discussion and not to limit the present disclosure, the complementary items are primarily described as organizers herein for organizing or storing a set of items. Some non-limiting examples of other complementary items that may be used with the present disclosure include batteries, accessories (e.g., jewelry for particular outfits), protective containers or cases (e.g., for tablets or smartphones), etc. As used herein, the term “item” is used interchangeably to refer to an item itself (e.g., a particular good, service, bundle of goods/services or any combination thereof) and to its description or representation in a computer system, such as an electronic catalog system. As will be apparent from the context in which it is used, the term is also sometimes used herein to refer only to the item itself or only to its representation in the computer system.

### Example Networked Computing Environment

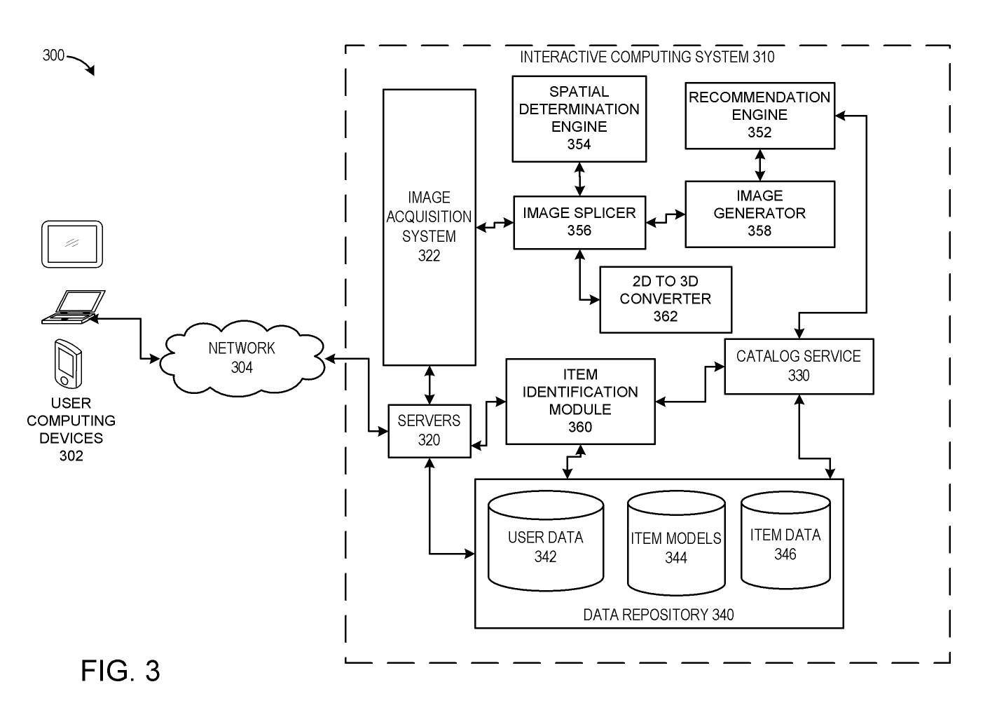

FIG. 3 illustrates an embodiment of a networked computing environment 300 that can implement the features described herein. The networked computing environment 300 may include a number of user computing devices 302 that can communicate with an interactive computing system 310 via a network 304. The interactive computing system 310 can generally include any system that can identify a complementary item for an item depicted in an image. However, as stated above, to simplify discussion and not to limit the disclosure, this application will primarily describe identifying organizer items that may be used to store and/or organize one or more items identified from an image. Nevertheless, it should be understood that the interactive computing system 310 may be used to identify other types of complementary items. For instance, presented with an image of a television, compatible DVD players may be presented to a user. As a second example, presented with an image of a shirt, matching skirts or pants may be presented to a user.

In some cases, the interactive computing system 310 may host a network application for identifying complementary items (e.g., organizer items) to be used with items depicted in an image. The interactive computing system 310 may be associated with a network or Internet-based store or retailer. In some cases, the interactive computing system 310 may be associated with an Internet-based store that is affiliated with a brick-and-mortar store or retailer.

The interactive computing system 310 can include a number of systems that facilitate implementing the processes described herein. In the depicted embodiment, the interactive computing system 310 includes several components that can be implemented in hardware and/or software. For instance, the interactive computing system 310 can include one or more servers 320, which may be implemented in hardware, for receiving and responding to network requests from user computing devices 302. However, some of the capabilities of the servers 320 may be implemented in software. The one or more servers 320 can include web servers, application servers, database servers, combinations of the same, or the like.

Further, the interactive computing system 310 may include a catalog service 330, which may provide an electronic catalog of items. Information about items included in the electronic catalog may be stored and accessed from an item data repository 346. Users can browse or search the electronic catalog provided by the catalog service 330 by accessing the servers 320 and/or querying a search engine (not shown) hosted by the interactive computing system 310.

The electronic catalog content can include information about items. In one embodiment, this content is arranged in a hierarchical structure, having items associated with one or more categories or browse nodes in a hierarchy. The catalog service 330 can provide functionality for users to browse the item hierarchy in addition to searching the catalog via a search engine.

In some cases, the hierarchical structure can include a tree-like structure with browse nodes that are internal nodes and with browse nodes that are leaf nodes. The internal nodes generally include children or descendent nodes and the leaf nodes generally do not include children nodes. The internal nodes may be associated with an item category or classification, which can include sub-classifications. The sub-classifications may represent additional internal nodes or leaf nodes. The leaf nodes may be associated with an item category or classification that does not include sub-classifications. In some implementations, the internal nodes are associated with item classifications and sub-classifications, but not items, and the leaf nodes are associated with the items. In other implementations, both the internal and leaf nodes may be associated with items.

Users can select an item represented in the hierarchy or in a list of search results to see more details about the item. In response to a user's item selection, the server 320 can provide to a user computing device 302 a catalog page (sometimes called an item detail page) that includes details about the selected item.

The interactive computing system 310 also includes a recommendation engine 352. The recommendation engine 352 can generally include any system for recommending one or more items or services to a user associated with the user computing devices 302. The recommendation engine 352 may recommend an item in response to a request from a user or from an administrator associated with the interactive computing system 310. In one embodiment, the recommendation engine 352 may recommend an item automatically without receiving a user request. In some cases, the recommendation engine 352 may recommend an item to a user in response to a passage of time since a previous purchase by the user.

In some embodiments, a user may request a recommendation of one or more items by providing access to an image of one or more other items. The recommendation engine 352 may identify items to recommend based on the items illustrated in the image. In some cases, the recommended items are complementary items to the items illustrated or depicted in the image. The complementary items may include items that are of a different type than the items illustrated in the image, but that can be used in conjunction with the items of the image. For instance, the complementary items may be organizer items that can be used to organize and/or store the items illustrated in the image. As further non-limiting examples, the complementary items may be batteries, protective cases, or add-ons (e.g., expansions to board games or downloadable content for video games) that can be used with the items illustrated in the image. In other cases, the recommended items are items of a related type. For instance, if the image illustrates books or movies, the recommended items may be other books or movies that may be related to the illustrated books or movies (e.g., sequels, of the same genre, or with an actor, director, or author in common).

In some embodiments, the recommendation engine 352 may select the recommended items based on a physical area illustrated in the image. The physical area is generally, although not necessarily, at least partially bounded. For instance, the physical area may be a drawer, a closet, a shelf on a wall or in a bookcase, or some area bounded on one or more planes. However, in some cases, the physical area may be relatively unbounded. For example, the physical area may be a location in a center of a room or in a yard, which may be bounded by the floor or ground, but unbounded on other planes.

According to some embodiments, the image may be any type of image that can be obtained by an optical device. For instance, the image may be a photograph or a frame of a video. The optical device may be a camera or other device capable of capturing an image. Further, the optical device may be a separate user device or may be a component of a user computing device 302. The recommendation engine 352 may analyze a copy of the image received at the interactive computing system 310 to develop its recommendations, or may use one or more additional systems (described below) hosted by the interactive computing system 310 to facilitate analyzing the image and developing the recommendations.

The interactive computing system 310 further includes an image acquisition system 322. The image acquisition system may include any system capable of receiving an image from a user computing device 302 and/or accessing an image from a data repository 340. The received image may be an image file, such as a JPEG, GIF, or bitmap file. In some cases, the received image is a frame from a streaming video or from a video file. Although illustrated as a separate component, in some cases, the image acquisition system 322 may be included in the servers 320.

As previously described, the recommendation engine 352 may recommend items based on items illustrated in an image and a physical area illustrated in the image. To facilitate analyzing the image received by the image acquisition system 322, the interactive computing system 310 may include a spatial determination engine 354 and an item identification module 360. Further, to facilitate analyzing the image, the image may include an illustration of a reference marker. A reference marker may itself be an image or an image of an object. For example, the reference marker may include the printout or an image of a printout of a tracer image. This tracer image may include an image previously provided to the interactive computing system 310 to serve as a reference for analyzing images. For example, the tracer image may be a machine-readable code, such as a barcode or a two-dimensional code, such as a Quick Response Code (“QR code”). Alternatively, or in addition, the tracer image may be a unique image generated for the purpose of serving as the tracer image. For example, the tracer image may be a stylized drawing of a dragon or some other creature. Alternatively, or in addition, the reference marker may be an image of a reference object. The reference object may include any object whose dimensions or spatial characteristics are provided to the interactive computing system 310. For example, the reference object may be an image of a user computing device or a block of wood with known dimensions. In some cases, the reference marker is provided to the interactive computing system 310. Alternatively, or in addition, characteristics of the reference marker, such as the dimensions of lines, shapes, and angles included in the reference marker, are provided to the interactive computing system 310.

The spatial determination engine 354 may include a system capable of determining the dimensions of a physical area illustrated in a received image. The dimensions may be determined by comparing the depiction of the physical area included in the image with the depiction of the reference marker included in the image. Further, one or more computer vision techniques and color identification techniques may be implemented to facilitate determination of the boundaries of the physical area. Further, in some cases, the spatial determination engine 354 may be used to determine the size of items depicted in an image. For instance, the spatial determination engine 354 may compare an object to the reference marker or reference object to determine proportions of an item depicted in an image.

The item identification module 360 may include a system capable of identifying items illustrated in a received image. In some embodiments, the item identification module 360 can identify the types of items included in the received image, the number of items included in the received image, and the dimensions of items included in the received image. In some cases, the item identification module 360 identifies the items in the received image and the dimensions of the items identified by comparing the depiction of the items with images of the item in an electronic catalog provided by the catalog service 330. Alternatively, or in addition, dimensions for the depicted items may be determined by comparing the depiction of the items included in the image with the depiction of the reference marker included in the image. Further, one or more computer vision techniques and/or color identification techniques may be implemented to facilitate identifying items in the image or in distinguishing between multiple items in the image.

As previously described, augmented reality techniques can be used to present a modified version of a received image to a user. This modified version of the received image may illustrate how the recommended item can be used with items illustrated in the received image. In some cases, because the modified version of the received image previews how the recommended item may be used in a particular context, the modified version of the received image may be referred to as a “preview image.” To facilitate generation of the modified version of the received image, the interactive computing system 310 includes an image generator 358. Further, in some cases, image generator 358 may use an image splicer 356 and/or a 2D to 3D converter 362 to facilitate generation of the preview image.

Image generator 358 may include a system capable of generating a two dimensional (2D) image and/or a three dimensional (3D) image based on a received image and one or more models of items. The models of the items may include electronic models or images of the items. In some cases, the models are templates of items. These templates may be wireframes or partially formed models of item, which can be used to create models of items using information obtained, for example, from the received image. For instance, size, color, and texture information may be obtained from the received image and used in conjunction with the template of an item to create a 3D model of the item.

The models of the items may include models for items identified from the received image and models for items identified for recommendation by the recommendation engine 352. In some cases, the image generator 358 creates a new image based on the received image and the one or more models of items. In other cases, the image generator 358 may modify the received image by replacing portions of the received image or overlaying one or more models of items over portions of the received image.

Although in some cases one or more models of the items may be 2D images, typically the one or more models are 3D images or models. The image generator 358 may position models for the items depicted in the received image with respect to a model for an item determined by the recommendation engine 352 to create a composite image. For example, if items depicted in the received image are shoes and the recommended item is a shoe rack, the image generator 358 may position 3D models for the shoes with respect to a 3D model for a recommended shoe rack so that the shoes are illustrated as being placed on shelves of the recommended shoe rack.

In some cases, the composite image is provided to the user computing devices 302 as a 3D image. Advantageously, in certain embodiments, providing the image as a 3D image enables a user to view the image with a user computing device 302 that has the capability to output or display a 3D image. Further, in certain embodiments, a user may alter the view of the 3D image to see a different perspective of the image. In other cases, the image generator 358 converts the 3D image into a 2D image before providing the composite image to the user computing device 302.

The image splicer 356 may include a system capable of dividing an image into multiple portions. In some cases, the image generator 358 may use the image splicer 356 to remove portions of a received image that includes items and to replace the removed portions with the 3D models of the items identified by the image generator 358 or the item identification module 360. In some embodiments, the image splicer 356 may be omitted or optional because, for example, the image generator 358 creates an image by overlaying image models on top of the received image or by creating a new image.

The 2D to 3D converter 362 may include a system capable of transforming a 2D image into a 3D image. To convert an image from a 2D image to a 3D image, the 2D to 3D converter 362 may apply one or more transformations to a portion of an image that includes a depiction of an item. In some cases, the 2D to 3D converter 362 may convert a 2D image of an item to a 3D image by extruding the 2D image. In some embodiments, the 2D to 3D converter 360 may determine how much to extrude and/or what other transformations to apply to a 2D image based on a comparison between the 2D image and a portion of the received image that includes the reference marker, such as by determining a perspective angle of the scene captured in the image based on skew and other characteristics identified from the reference marker depicted in the image.

The data repository system 340 can generally include any repository, database, or information storage system that can store information associated with items and users. This information can include any type of data, such as item descriptions, account information, customer reviews, item tags, or the like. Further, this information can include relationships between items, between users, and/or between items and users.

The data repository 340 can include a user data repository 342, an item models repository 344, and an item data repository 346. The user data repository 342 can store any information associated with a user including account information, user purchase information, user demographic data, item view information, user searches, identity of items owned by a user (e.g., purchased or obtained as a gift) or the like.

The item data repository 346 can store any information associated with an item. For example, the item data repository 346 can store item descriptions, customer reviews, item tags, manufacturer comments, service offerings, etc. In some embodiments, item data stored for at least some of the items identified in the item data repository 346 may include, but is not limited to, price, availability, title, item identifier, item feedback (e.g., user reviews, ratings, etc.), item image, item description, item attributes (such as physical dimensions, weight, available colors or sizes, materials, etc.), keywords associated with the item, and/or any other information that may be useful for presentation to a potential purchaser of the item, for identifying items similar to each other, and/or for recommending items to a user.

One or more of the user data repository 342 and the item data repository 346 can store any information that relates one item to another item or an item to a user. For example, the item data repository 346 can include information identifying items that were first available in a specific year, items that share an item classification, or items that share a sales ranking (e.g., items on top ten sales list by volume and/or by monetary sales numbers).

The item models repository 344 may store images representative of items included in an electronic catalog provided by the catalog service 330. The images may be 2D images or 3D images. Further, the images may serve as templates that can be used by the image generator 358 to create models of items and/or a composite image that can include multiple items and/or which may be joined or otherwise merged with an image provided by a user computing device 302.

The various components of the interactive computing system 310 may be implemented in hardware, software, or combination of hardware and software. In some cases, some components may be implemented in hardware while other components of the interactive computing system 310 may be implemented in software or a combination of hardware and software. For example, in one embodiment, the image acquisition system 322 and the recommendation engine 352 may be implemented in hardware, while the image generator 358 and the image splicer 356 may be implemented in software. Further, the data repositories 340 may be implemented in the storage systems of the servers 320 or may be implemented in separate storage systems.

The user computing devices 302 can include a wide variety of computing devices including personal computing devices, tablet computing devices, electronic reader devices, mobile devices (e.g., mobile phones, media players, handheld gaming devices, etc.), wearable devices with network access and program execution capabilities (e.g., “smart watches” or “smart eyewear”), wireless devices, set-top boxes, gaming consoles, entertainment systems, televisions with network access and program execution capabilities (e.g., “smart TVs”), kiosks, speaker systems, and various other electronic devices and appliances. Further, the user computing devices 302 can include any type of software (such as a browser) that can facilitate communication with the interactive computing system 310. In some cases, a user may access the interactive computing system 310 via a network page hosted by the interactive computing system 310 or by another system. In other cases, the user may access the interactive computing system 310 via an application.

The network 304 may be a publicly accessible network of linked networks, possibly operated by various distinct parties. Further, in some cases, the network 304 may include the Internet. In other embodiments, the network 304 may include a private network, personal area network, local area network, wide area network, cable network, satellite network, cellular telephone network, etc., or combination thereof, each with access to and/or from an external network, such as the Internet.

The architecture of the interactive computing system 310 may include an arrangement of computer hardware and software components as previously described that may be used to implement aspects of the present disclosure. The interactive computing system 310 may include many more (or fewer) elements than those illustrated. It is not necessary, however, that all of these elements be shown in order to provide an enabling disclosure. Further, the interactive computing system 310 may include a processing unit, a network interface, a computer readable medium drive, an input/output device interface, a display, and an input device, all of which may communicate with one another by way of a communication bus. The network interface may provide connectivity to one or more networks or computing systems. The processing unit may thus receive information and instructions from other computing systems or services via the network 304. The processing unit may also communicate to and from memory and further provide output information for an optional display via the input/output device interface. The input/output device interface may also accept input from the optional input device, such as a keyboard, mouse, digital pen, microphone, touch screen, gesture recognition system, voice recognition system, image recognition through an imaging device (which may capture eye, hand, head, body tracking data and/or placement), gamepad, accelerometer, gyroscope, or other input device known in the art.

The memory may contain computer program instructions (grouped as modules or components in some embodiments) that the processing unit executes in order to implement one or more embodiments. The memory may generally include RAM, ROM and/or other persistent, auxiliary or non-transitory computer-readable media. The memory may store an operating system that provides computer program instructions for use by the processing unit in the general administration and operation of the interaction service. The memory may further include computer program instructions and other information for implementing aspects of the present disclosure. For example, in one embodiment, the memory includes a user interface module that generates user interfaces (and/or instructions therefor) for display upon a computing device, e.g., via a navigation interface such as a browser or application installed on the computing device. In addition, memory may include or communicate with an image data repository, a dimension data repository, and/or one or more other data stores.

Further, although certain examples are illustrated herein in the context of an interactive computing system 310 that communicates with a separate user computing device 302, this is not a limitation on the systems and methods described herein. It will also be appreciated that, in some embodiments, a user computing device 302 may implement functionality that is otherwise described herein as being implemented by the elements and/or systems of the interactive computing system 310. For example, the user computing devices 302 may generate composite images based on images of items and an image of a recommended complementary item without communicating with a separate network-based system, according to some embodiments.

### Example Organizer Preview Process

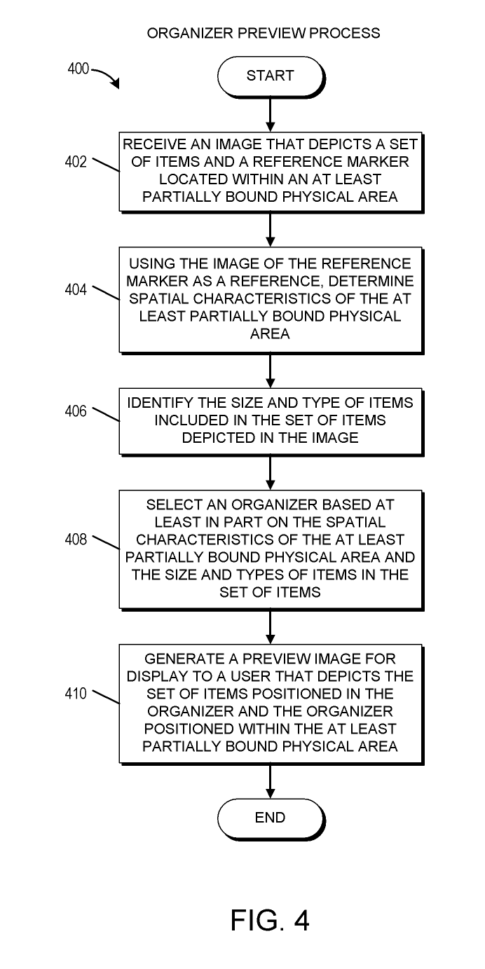

FIG. 4 is a flowchart of an illustrative embodiment of an organizer preview process 400. The process 400 can be implemented by any system that can identify an organizer based on an image of a set of items and generate a preview image of the organizer used in conjunction with the set of items. For example the process 400, in whole or in part, can be implemented by an interactive computing system 310, an image acquisition system 322, a recommendation engine 352, a spatial determination engine 354, an image splicer 356, an image generator 358, an item identification module 360, and/or a 2D to 3D converter 362, to name a few. Although any number of systems, in whole or in part, can implement the process 400, to simplify the discussion, portions of the process 400 will be described with reference to particular systems.

The process 400 begins at block 402 where, for example, the image acquisition system 322 receives an image that depicts a set of items and a reference marker located within an at least partially bounded physical area. The image may be a static image, such as a photograph, or a set of images, such as one or more frames from a video. Further, the reference marker may be or include an object with spatial characteristics previously provided to the interactive computing system 310. For example, the reference marker may be a tracer printout or a printout of an image with a particular size known by or previously provided to the interactive computing system 310. For instance, although not limited as such, the reference marker may be a fanciful design or a machine-readable code, such as a barcode, QR code, matrix code, and the like. In some cases, the reference marker may be a three-dimensional object, such as a block of wood, a coin or other piece of currency, a deck of cards, a board game, a glass, a phone, or any other item for which the interactive computing system 310 has stored dimension information or is provided with dimension information or spatial information. The dimensions of the reference marker may be provided by an administrator or a customer user.

The partially bounded physical area may include an area designated by a user for storing the set of items. For example, the partially bounded physical area may be a storage space, such as a closet, a drawer, or a shelf. However, embodiments disclosed herein are not limited to use with a bounded physical area. For example, embodiments disclosed herein may be used with an open space in a room or in a space external to a building, such as a backyard. Thus, in certain embodiments, the image received at the block 402 may illustrate a set of items and a reference marker in an unbounded space.

At block 404, the spatial determination engine 354, using as a reference a portion of the image that includes the reference marker, determines spatial characteristics of the at least partially bounded physical area. The spatial determination engine 354 may determine the area or volume of the at least partially bounded physical area depicted in the image. Further, in some cases, the spatial determination engine 354 may use the item identification module 360 to determine characteristics of boundaries within the at least partially bounded physical area. For example, the item identification module 360 may determine whether there is a door in the at least partially bounded physical area. In some cases, if the spatial characteristics of the at least partially bounded physical area cannot be determined, a message may be presented to a user to reposition the user computing device 302 to obtain a modified version of the image received at the block 402. Moreover, in certain embodiments, the block 404 may be optional or omitted.

The spatial determination engine 354 may determine spatial characteristics of the at least partially bounded physical area by using one or more computer vision algorithms, such as template matching. Further, the spatial determination engine 354 may compare elements of the image with unknown proportions to the portion of the image that includes the reference marker, which has known proportions, to determine the unknown proportions. For example, the spatial determination engine 354 may analyze a digital photograph (or frame of streaming video data) captured by a camera device and determine the camera's angle and distance from the reference marker by comparing a straight-on previously-stored image of the reference marker to a depiction of the reference marker as placed in the physical environment captured in the photograph.

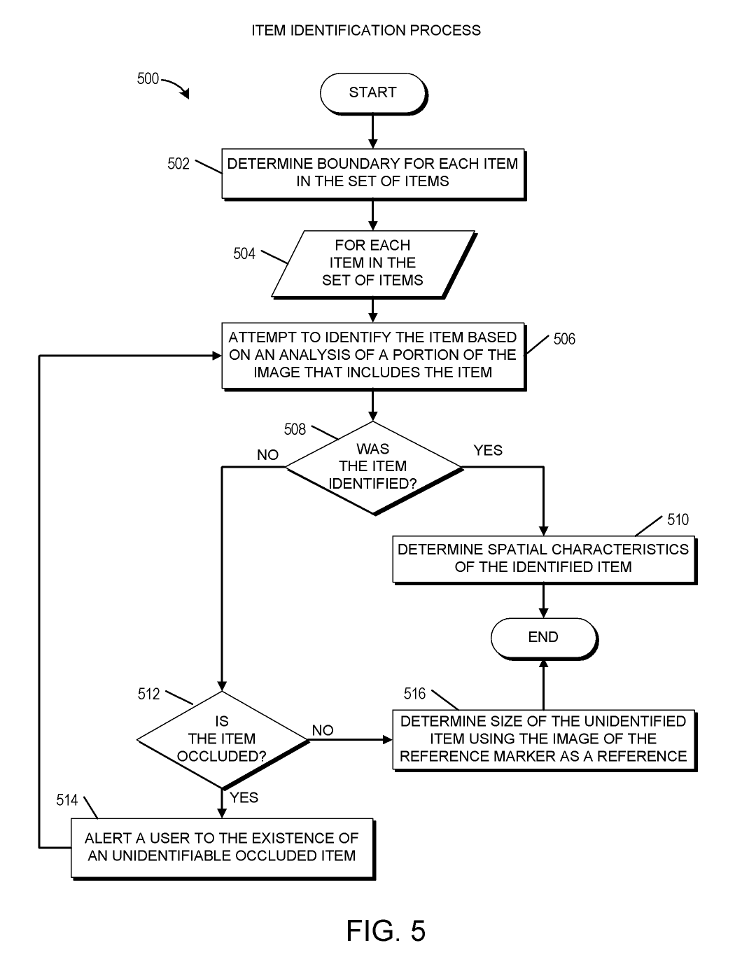

At block 406, the item identification module 360 identifies the size and the type of items included in the set of items depicted in the image received at the block 402. Further, the block 406 may include determining the number of items depicted in the image. One or more image analysis processes may be used at the block 406 to determine the number and types of items included in the image. Continuing the above illustrative example, based on the distance and angle information determined for the reference marker in the captured image, the item identification module 360 may determine distance, size and/or angle information for one or more items in the image based at least in part on the size and position within the image of each item relative to the size and position within the image of the reference marker. Some example processes that may be used with respect to the block 406 are described in more detail below with respect to FIG. 5.

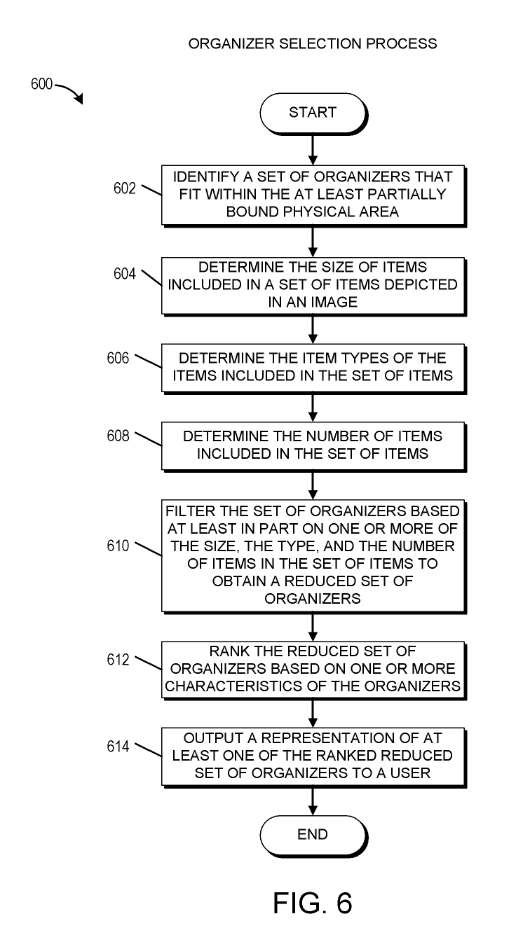

At block 408, the recommendation engine 352 selects an organizer based at least in part on the spatial characteristics of the at least partially bounded area and the size and type of items in the set of items. Further, the recommendation engine 352 may select the organizer based on the number of each type of the items included in the set of items. In some cases, the recommendation engine 352 identifies a number of organizers and selects one based on input from a user or one or more ranking characteristics for the organizers, such as rating, conversion rate, price, inventory, etc. One or more selection and/or recommendation processes may be used at the block 408 to select the organizer. Some example processes that may be used with respect to the block 408 are described in more detail below with respect to FIG. 6.

The image generator 358, at block 410, generates a preview image for display to a user that depicts the set of items positioned with respect to the selected organizer and the selected organizer positioned with respect to the at least partially bounded physical area. The generated preview image may be displayed on a screen of the user computing device 302 that captured and/or provided the image received at the block 402. The presentation of the preview image to the user may be a form of augmented reality. Advantageously, in certain embodiments, the process 400 enables a user to view how the user may use a particular organizer with a set of items of the user in a particular location that the user views via a camera or similar component of the user's user computing device 302. For example, while a camera of a user computing device 302 of a user captures an image of the user's closet filled with shoes on the floor or in some disorganized arrangement, a display of the user computing device 302 may present an image of the user's closet that depicts the shoes positioned within a shoe rack in an organized arrangement. Thus, advantageously, the user may preview the use of a particular shoe rack with respect to the user's shoes without purchasing or obtaining an instance of the shoe rack. For a particular user, previewing the shoe rack using shoes of the user in a location that the user intends to use the shoe rack may be more likely to result in a sale than viewing a stock or generic image of the shoe rack outside of a context specific to the user. In some embodiments, the angle and/or size of the augmented reality portion of the preview image (e.g., the presentation of the selected organizer and the set of items included therein or thereon) may be continuously adjusted and updated on the display of the user computing device 302 as the user moves the position of the camera.

### Example Item Identification Process

FIG. 5 is a flowchart of an embodiment of an item identification process 500. The process 500 can be implemented by any system that can identify one or more items in an image. For example the process 500, in whole or in part, can be implemented by an interactive computing system 310, an image acquisition system 322, a recommendation engine 352, a spatial determination engine 354, an image splicer 356, an image generator 358, an item identification module 360, and/or a 2D to 3D converter 362, to name a few. Although any number of systems, in whole or in part, can implement the process 500, to simplify the discussion, portions of the process 500 will be described with reference to particular systems.

In certain embodiments, the process 500 may be used in conjunction with the process 400. For example, some or all of the process 500 may be performed as part of the block 406. Further, the process 500 may begin or be performed after an image is received at the block 402 as previously described above with respect to FIG. 4.

The process 500 begins at block 502 where, for example, the item identification module 360 determines a boundary for each item in a set of items depicted in an image received, for example, at the block 402 of FIG. 4. To simplify further discussion, and not to limit the present disclosure, the image received at the block 402 may be referred to as the “image under test” or the “image under analysis.” In some cases, the block 502 is performed for a subset of items included in the image under analysis. The block 502 may include performing one or more computer vision algorithms to differentiate an image of an item from other portions of the image under analysis.

Further, the block 502 may include filtering out indistinguishable items, a background in the image under analysis, or other portions of the image under analysis that is unrecognizable. In some cases, the block 502 may filter out recognizable items that are determined to be inappropriate for use with an organizer item. For example, the block 502 may filter out a lamp from the set of items to be identified in the image under analysis. In some embodiments, unrecognizable portions of the image under analysis may be circled or otherwise annotated and presented to a user. In such cases, the item identification module 360 may receive an indication from the user of an item type for an unrecognizable portion of the image under analysis or may receive an indication that the unrecognizable portion of the image under analysis is to be ignored for the purposes of performing the process 500.

As indicated by block 504, the remainder of the process 500 is performed for each individual item in the set of items whose boundary is determined at the block 502. This can include, in some cases, processing a plurality of items, at least initially, as a single item due, for example, to at least partial occlusion of one item by another item. It should be understood that each item may be processed sequentially or at least partially in parallel. Further, it should be understood that the process 500 may process a subset of items illustrated in the image under test. To simplify discussion, the remainder of the process 500 will be described with respect to a single item. However, it should be understood that multiple related or unrelated items may be processed by the process 500. For example, a pair of shoes or a number of spoons may be processed separately or at least partially together by the process 500.

At the block 506, the item identification module 360 attempts to identify the item based on an analysis of a portion of the image under test that includes the item. A number of image analysis techniques may be performed sequentially or at least partially in parallel to identify the item. For example, the portion of the image under test that includes the item may be scanned for a machine-readable code, such as a barcode, QR code, or other unique code that may be used for identification or inventory purposes. If a machine-readable code is identified, the item may be identified based on the machine-readable code by, for example, accessing an electronic catalog provided by the catalog service 330.

As a second example, a portion of the image under test may be processed by an optical character recognition (“OCR”) process to determine whether the portion of the image includes text. If text is identified, a search of the electronic catalog may be performed using the text in an attempt to identify the item. Further, in some cases, the text may be supplied to a search engine that may search one or more network sites including, in some cases, network sites hosted on the Internet in an attempt to identify the item.

As a third example, a portion of the image under test may be processed using one or more image comparison algorithms to determine whether a portion of the image under test matches an image of a known item. The images of the known item may include images of items in an electronic catalog provided by the catalog service 330. As will be appreciated, one or more transformations may be applied to the portion of the image prior to or during the comparison to images of known items in order to account for an angle of the camera that captured the image.

In some cases, the image analysis may include creating a fingerprint of the portion of the image under test that includes the item. This fingerprint may be based on identifiable characteristics of the item in the portion of the image under test. For example, the fingerprint may include a location of vertices that define a tracing or wireframe of the item in the image. Further, the fingerprint may include the identity of colors corresponding to portions of the item. The fingerprint for the item may then be compared to fingerprints of items included in the electronic catalog to identify the item or a category for the item.

At the decision block 508, the item identification module 360 determines whether the item was identified. If the item was successfully identified, the spatial determination engine 354 determines spatial characteristics of the identified item at the block 510. Identifying the spatial characteristics of the identified item may include accessing item data and/or models for the identified item at one or more of the data repositories 340. In some embodiments, the block 510 may include using a reference marker or reference object included in the image under analysis to facilitate determining the spatial characteristics of the identified item. For example, if the identified item is available in three different sizes, the image of the item may be compared to the reference marker to determine the size of the item included in the image under analysis.

If it is determined at the decision block 508 that the item was not successfully identified, the item identification module 360 attempts to determine whether the item is occluded at the decision block 512. The item may be identified as occluded if the item is partially obscured from view by another item, but enough of the item is viewable by an image acquisition device of a user computing device 302 for the item identification module 360 to determine that multiple items may be included in a portion of the image under analysis. For example, suppose that the image under analysis includes a shoe that is 90% covered by a blanket. The item identification module 360 may determine that an item exists under the blanket based on the 10% of the shoe that is not covered by the blanket. However, in some cases, the item identification module 360 may be unable to determine that the covered item is a shoe. Moreover, in some cases, the item identification module 360 may be unable to distinguish between an unidentifiable item and an occluded item.

In some cases, the unidentified occluded item may be ignored. However, in other cases, the item identification module 360 alerts a user to the existence of the unidentifiable occluded item at the block 514. Advantageously, in certain embodiments, by alerting the user of the unidentifiable occluded item, the user may de-occlude the item, or uncover the item, in the physical environment and capture a new image of the adjusted environment, such that the item identification module 360 may determine the type of the previously occluded item. The item identification module 360 may alert the user to the occluded item by using a bounding box or other user interface feature to annotate a portion of the image under analysis that includes the unidentified included item. In some cases, the user may indicate that the item is not occluded. In some such cases, the user may provide an identity of the item.

In some embodiments, the process 500 may wait or pause until the user de-occludes the item. In other cases, the occluded item may be ignored. In yet other cases, the occluded item and a second item occluding the occluded item may be treated as a single unrecognizable item and may be processed as described below with respect to the block 516. Thus, in certain embodiments, the block 512 may be omitted or optional.

If it is determined that the item is not occluded at the decision block 512, the spatial determination engine 354 determines the size of the unidentified item using an image of the reference marker as a reference at block 516. The portion of the image that includes the unidentified item may be compared to the portion of the image that includes the reference marker. As the spatial characteristics of the reference marker are known (e.g. stored at the data repository 340), the size of the unidentified item may be determined based on the comparison to the reference marker. In some embodiments, the collective size of multiple items may be determined at the block 516 instead of determining individual sizes of each item. For example, as previously described, if the item identification module 360 is unable to separate a pair of items, the pair of items may effectively be treated as a single item for purposes of the process 500.

### Example Organizer Selection Process

FIG. 6 is a flowchart of an embodiment of an organizer selection process 600. The process 600 can be implemented by any system that can identify one or more organizer items based at least in part on an image of a set of items. For example the process 600, in whole or in part, can be implemented by an interactive computing system 310, an image acquisition system 322, a recommendation engine 352, a spatial determination engine 354, an image splicer 356, an image generator 358, an item identification module 360, and/or a 2D to 3D converter 362, to name a few. Although any number of systems, in whole or in part, can implement the process 600, to simplify the discussion, portions of the process 600 will be described with reference to particular systems.

In certain embodiments, the process 600 may be used in conjunction with the process 400. For example, some or all of the process 600 may be performed as part of the block 408. Further, the process 600 may begin or be performed after an image is received at the block 402 as previously described above with respect to FIG. 4.

The process 600 begins at block 602 where, for example, the recommendation engine 352 identifies a set of organizers that fit within the at least partially bounded physical area illustrated in the image under analysis. The spatial characteristics of the bounded physical area may be determined from a reference marker included in the image under test as previously described with respect to the block 404. The set of organizers may include organizers that are smaller than the at least partially bounded physical area. In some cases, the set of organizers may include organizers that are within a threshold size larger than the at least partially bounded physical area. For example, if the at least partially bounded physical area includes a shelf, an organizer that would extend partially off of the shelf if positioned on the shelf may be included in the set of organizers. However, if the organizer would extend beyond a threshold distance off of the shelf, the organizer may be excluded from the set of organizers. The threshold used to determine how much an organizer may exceed the at least partially bounded physical area may vary based on the type of organizer and characteristics of the partially bounded physical area. For instance, the threshold may be much smaller for an area that includes a door (e.g., a closet) than for an area that does not include a door (e.g., a shelf on a wall external to a closet).

At block 604, the item identification module 360 determines the size of the items included in a set of items illustrated in the image under analysis. Further, at block 606, the item identification module 360 determines the item types of the items included in the set of items. In certain embodiments, the block 604 and the block 606 may include performing one or more of the processes described with respect to the process 500.

The item identification module 360 determines the number of items included in the set of items at the block 608. Determining the number of items may include determining a number of items of a particular item type. In some cases, items may be associated with multiple item types. In such cases, multiple counts of items may be performed at the block 608 based on different classifications of items depicted in the image under analysis. For instance, an item may be identified as a tool, a screwdriver, and/or a slotted screwdriver.

At the block 610, the recommendation engine 352 filters the set of organizers based at least in part on one or more of the size, the type, and/or the number of items in the set of items to obtain a reduced set of organizers. It should be understood that in some cases the reduced set of organizers may equal the set of organizers identified at the block 602. For example, if each of the set of organizers identified at the block 602 satisfies the filtering criteria used at the block 610, the reduced set of organizers will include each of the organizers identified at the block 602. Further, the block 610 may include filtering the set of organizers based on particular features of the organizers. For example, if it is determined at the block 606 that the items are various types of jewelry, the block 610 may include filtering the set of organizers to remove organizers that do not have a lock or to remove organizers that are not fully enclosed. As a second example, if it is determined at the block 606 that the items are various types of hand tools, the block 610 may include filtering set of organizers to remove organizers that are not portable containers. In some cases, the filtering criteria may be selected automatically based on the types of items to be used with the organizer. Alternatively, or in addition, the filtering criteria may be selected by a user.

At block 612, the recommendation engine 352 may rank the reduced set of organizers based on one or more characteristics of the organizers. While at the block 610 the set of organizers may be filtered based at least in part on characteristics of the items depicted in the image under analysis, the characteristics used to rank the reduced set of organizers are typically independent of the items in the image under analysis. For example, the characteristics used to rank the reduced set of organizers may include price, customer ratings, rate of sales conversion for organizers accessed or presented to a user, sales ranking, inventory, whether the organizer item is still being manufactured, etc. In some cases, the recommendation engine 352 may rank the reduced set of organizers based on a user profile associated with the user. For example, if it has been determined based on, for example, prior purchases or item accesses by the user that the user tends to prefer wood-based items over metal-based items, organizers made from wood may be ranked higher than organizers made from metal. In some embodiments, the block 612 may be optional or omitted. For example, the reduced set of organizers may be presented to a user in a random order.

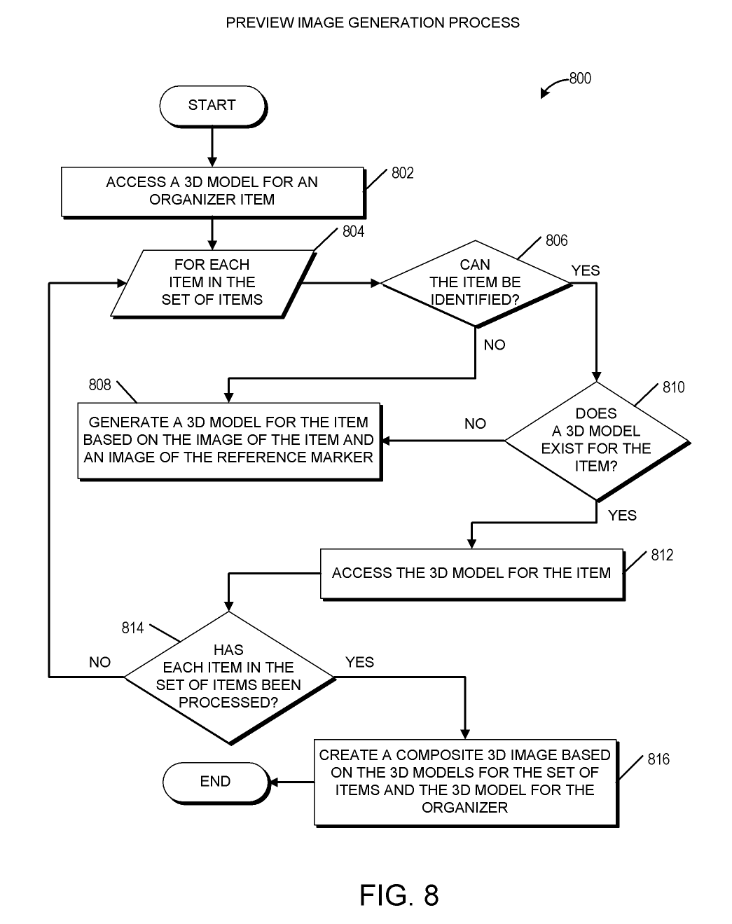

At block 614, the recommendation engine 352 outputs a representation of at least one of the ranked reduced set of organizers to a user. The representation may include a list of the reduced set of organizers, item detail information for the reduced set of organizers, images for the reduced set of organizers, or any other type of output that may be used to present the reduced set of organizers to the user. In some embodiments, a preview image of at least one of the organizer items may be presented to the user. In some cases, an organizer may automatically be selected from the reduced set of organizers and a preview image for the selected organizer may automatically be created and presented to the user. Alternatively, an organizer may be selected by a user and a preview image of the organizer may be presented to the user automatically or in response to a command from the user. Some example processes that may be used with respect to the block 614 for presenting a preview image of an organizer to a user are described in more detail below with respect to FIG. 8.

In some embodiments, the recommendation engine 352 recommends one or more of the organizers included in the ranked reduced set of organizers to a user. The recommendation may be based on one or more of the factors used to rank the reduced set of organizers at the block 612. Alternatively, in some implementations, the recommendation engine 352 presents one or more organizers to a user that satisfy the filtering criteria of the block 610 and/or the ranking criteria of the block 612 without making a recommendation of a particular organizer or set of organizers.

In some implementations, the recommendation engine 352 may recommend multiple instances of an organizer or a varied set of organizers. For example, if it is determined that a user has 50 items to be organized, but the largest organizer that is capable of storing or organizing the items is limited to 30 items, the recommendation engine 352 may recommend two of the organizers that can each hold 30 items. Alternatively, or in addition, the recommendation engine 352 may recommend one of the organizers that can hold 30 items and another organizer that can hold 20 items. Moreover, the set of identified organizers may be filtered and/or ranked based at least in part on the number of organizers a user may require to organize all of the user's items and/or on whether matching sets of organizers exist of different sizes. For instance, a pair of organizers that have a matching cherry wood finish may be ranked above another pair of organizers that include one organizer with an oak finish and another organizer that is metal. In some cases, different organizers may be recommended for different types of items included in the set of items identified from the image under analysis. For instance, supposing that an image depicts a number of wine glasses and a number of coffee cups in a cabinet, one organizer may be identified for the wine glasses and another organizer may be identified for the coffee cups. Further, continuing the previous example, the organizers may be of a matching style, may be stackable, and/or may be the cheapest pair regardless of whether the organizers match. In some implementations, the recommendation engine 252 may recommend one organizer based on another organizer selected by the user. For instance, if the user selects a specific organizer for the wine glasses, a particular organizer or set of organizers, may be recommended for the coffee cups based at least in part on the user's selection of the wine glass organizer. In addition, a preview image may be generated that includes displaying multiple organizers and/or the mixed set of recommended organizers illustrating how the organizers may be used with the items of the user.

### Example Organizer Preview Selection Process

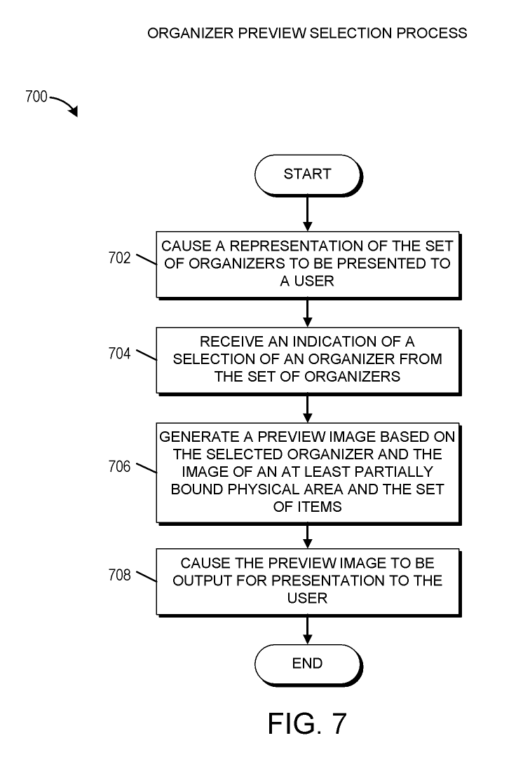

FIG. 7 is a flowchart of an embodiment of an organizer preview selection process 700. The process 700 can be implemented by any system that can receive a selection of an organizer item to preview in conjunction with a set of items. For example the process 700, in whole or in part, can be implemented by an interactive computing system 310, an image acquisition system 322, a recommendation engine 352, a spatial determination engine 354, an image splicer 356, an image generator 358, an item identification module 360, and/or a 2D to 3D converter 362, to name a few. Although any number of systems, in whole or in part, can implement the process 700, to simplify the discussion, portions of the process 700 will be described with reference to particular systems.

In certain embodiments, the process 700 may be used in conjunction with the process 600. For example, some or all of the process 700 may be performed as part of the block 614. Further, the process 700 may begin or be performed after an image is received at the block 402 as previously described above with respect to FIG. 4.

The process 700 begins at block 702 where, for example, the recommendation engine 352 causes a representation of a set of organizers to be presented to a user. The set of organizers may be determined based at least in part on an image received by an image acquisition system 322. In some cases, a set of organizers may be determined using the process 600. The representation of the set of organizers may be presented to the user on a display of a user computing device 302 associated with the user. In some embodiments, the block 702 may include one or more of the embodiments described with respect to the block 614.

At block 704, the recommendation engine 352 receives an indication of a selection of an organizer from the set of organizers. The indication of the selection of the organizer may be received from a user computing device 302. Alternatively, the selection of the organizer may be performed automatically by the recommendation engine 352.

The image generator 358 generates at block 706 a preview image based on the selected organizer and an image of an at least partially bound physical area (e.g., a storage space) and a set of items received at the block 402. In some embodiments, the image generator 358 generates a 3D scene based on the selected organizer and an image of an at least partially bound physical area and a set of items. The preview image may then be generated by rendering a 2D image of the 3D scene. Alternatively, the preview image may be a 3D image based on the 3D scene. Some example processes that may be used with respect to the block 706 for generating a preview image of an organizer for presentation to a user are described in more detail below with respect to FIG. 8.

At block 708, the recommendation engine 352 causes the preview image to be output for presentation to the user. As stated above, in some embodiments, the preview image is a 3D image or model. In some cases, the user may view the 3D image on a display capable of displaying a 3D image. In such cases, the user may interact with the 3D image using to rotate or view the image from different angles. In other cases, the user may view a 2D rendering of the 3D image on a display capable of displaying 2D images. Further, in some such cases, a user may interact with a user interface to modify a view of the image. For instance, the user may provide a command to rotate the image. In such cases, the 3D model may be rotated and a new 2D image may be rendered from the rotated 3D model. The new 2D image may then be displayed to the user thereby enabling the user to preview the organizer item from different perspectives. In some implementations, the preview image may be presented or viewed from an angle corresponding to the angle of the image received at the block 402. In some such cases, an updated view of the 3D model may be presented and/or an updated preview image may be generated and presented to the user in response to the user moving the user computing device 302.

### Example Preview Image Generation Process

FIG. 8 is a flowchart of an embodiment of a preview image generation process 800. The process 800 can be implemented by any system that can generate a preview of an organizer used in conjunction with a set of items based on a received image of the items. For example the process 800, in whole or in part, can be implemented by an interactive computing system 310, an image acquisition system 322, a recommendation engine 352, a spatial determination engine 354, an image splicer 356, an image generator 358, an item identification module 360, and/or a 2D to 3D converter 362, to name a few. Although any number of systems, in whole or in part, can implement the process 800, to simplify the discussion, portions of the process 800 will be described with reference to particular systems.

In certain embodiments, the process 800 may be used in conjunction with the process 700. For example, some or all of the process 800 may be performed as part of the block 706. Further, in certain embodiments, the process 800 may be used in conjunction with the process 600. For example, some or all of the process 800 may be performed as part of the block 614. In some implementations, the process 800 may begin or be performed after an image is received at the block 402 as previously described above with respect to FIG. 4.

The process 800 begins at block 802 where, for example, the image generator 358 accesses a 3D model from the item models repository 344 for an organizer item. This organizer item may be an organizer selected by a user from an electronic catalog or from a set of organizer items presented to the user by, for example, a recommendation engine 352. In some cases, the organizer item may be automatically selected by the recommendation engine 352. For example, the organizer item may be an organizer selected by implementing one or more of the processes 600 and 700.

As indicated by the block 804, a portion of the process 800 is repeated for each item in a set of items illustrated in an image under analysis. As previously stated, the image under analysis may include the image received at the block 402 with respect to the process 400. In some embodiments, the process 800 is performed for a subset of items illustrated in an image under analysis. It should be understood that each item may be processed sequentially or at least partially in parallel using the process 800. To simplify discussion, remainder of the process 800 will be described with respect to a single item. However, it should be understood that multiple related or unrelated items may be processed by the process 800. For example, a set of drinking glasses may be processed separately or at least partially together by the process 800.

At the decision block 806, for a particular item illustrated in the image under analysis, the item identification module 360 determines whether the item can be identified. Determining whether the item can be identified may include performing one or more operations with respect to the process 500. If the item cannot be identified, the image generator 358 generates a 3D model for the item at block 808. In some cases, such as if the image under analysis is a 3D image, the 3D models for the item is extracted from the image under analysis. However, in other cases, such as when the image under analysis is a 2D image, the 3D model for the item is created by processing a portion of the image under analysis that includes the item using a 2D to 3D converter 362 to generate the 3D image.

Generating the 3D model for the item may include determining the size of the item by comparing the portion of the image under analysis that includes the item to the portion of the image under analysis that includes the reference marker. Further, generating the 3D model for the item may include performing one or more transformations on the portion of the image under analysis that includes the item. In some cases, the transformation operations may include extruding a 2D image to create a 3D model based on the determined size of the item. For instance, suppose that an item is depicted in the image under analysis with a height of 6 inches. Further suppose, based on a comparison of the portion of the image that includes the item to the portion of the image that includes a reference marker, that the item is actually 24 inches. In such a case, the image of the item included in the image under analysis may be extruded, scaled, or transformed such that a height of the 3D model of the item corresponds to a height of 24 inches.

If it is determined at the decision block 806 that the item can be identified, the item identification module 360 determines whether a 3D model exists for the item at the decision block 810. If a 3D model does not exist for the item, the process 800 proceeds to the block 808 and generates a 3D model for the item as described above. If a 3D model does exist for the item, the image generator 358 accesses at block 812 the 3D model for the item from a repository, such as the item models repository 344. In some cases, the 3D model shares characteristics of the identified item. For example, the 3D model is of the same size and/or color of the item. In other cases, the 3D model does not share at least some characteristics of the item. For example, a single 3D model may exist for a shoe. However, shoes generally are available in a variety of sizes. In such cases, the 3D model may be accessed for the shoe regardless of differing characteristics between the 3D model and the identified shoe. In other words, in some cases, the 3D model may serve as a template that is representative of the identified item and which may be modified to match the characteristics of the identified item.

Modifying the 3D model to match the characteristics of the item may include performing a number of transformations to the 3D model. In some cases, the image generator 358 using, for example, the item identification module 360 may determine a size of the item in the image by, for example, comparing the image of the item to the image of a reference marker. The image generator 358 may modify the size of the 3D model based on the identified size of the item. Further, the image generator 358 may determine a color and/or texture of the item in the image and modify the 3D model to be of the identified color and/or texture. In certain embodiments, the image generator 358 may sample the color of the item in the image and apply the sampled color to the 3D model. Alternatively, or in addition, the image generator 358 may use the image of the item to create a texture, which may then be applied to the 3D model. Advantageously, in certain embodiments, by using the image of the item as a texture for the 3D model, unique aspects of the user's item may be applied to the 3D model resulting in a more accurate representation of the user's item. The unique aspects of the user's item may include aspects that are unique to the user's item or are included on less than a threshold number of items. These unique aspects may include, for example, discolorations, scratches, chips, markings, and/or modifications to the user's item or less than a threshold number of items.

At decision block 814, the image generator 358 determines whether each item in the set of items illustrated in image under analysis has been processed. If one or more items depicted in the image under analysis have not yet been processed, the process 800 returns to the block 804 to continue processing items illustrated in the image under analysis. If it is determined that each of the items in a set of items depicted in the image under analysis has been processed, the process 800 proceeds to the block 816.

At block 816, the image generator 358 creates a composite 3D image based on the 3D models for the set of items in the 3D model for the organizer. A 3D model for each item of at least some items may be individually positioned with respect to the 3D model for the organizer. In some cases, positioning the 3D model for some items may include positioning the 3D model for the items within a portion of the 3D model for the organizer representing a compartment of the organizer. In some cases, the compartment may be specifically configured to store items of a particular type. For instance, the compartment may include special material to protect fragile items. As a second example, the compartment may be configured to maintain a specific temperature or a temperature range.

In some implementations, generating the composite 3D image may include creating a 3D image scene by positioning the 3D model of one or more items with respect to the 3D model of the organizer. The combined 3D model of the organizer and 3D model of one or more items may be positioned or oriented with respect to a reference marker included in the image under analysis. In some cases, the 3D scene may be rendered as a 2D image and the resulting 2D image may be positioned with respect to a background of the image under analysis or a copy of the image under analysis to create a composite 2D image. The composite 2D image may be provided to a user computing device 302 for display to a user as previously described with respect to FIG. 7.

In some cases, multiple items may be illustrated in the image under analysis. In some such cases, the items may be stacked when used with a recommended organizer item. Thus, in some cases, the 3D models of the items may be stacked when positioned relative to the 3D model of the organizer. In some embodiments, the block 816 may include rendering a 2D image or view of the composite 3D image.

In certain embodiments, a histogram may be created to illustrate to the user the number of items in the image under test that are the same or are of a particular type. The histogram may be displayed separately or as part of the composite 3D image created at the block 816.

In cases where multiple items may be represented by a single 3D model or a stacked set of 3D models, a 3D model or stacked set of 3D models may be positioned together with respect to the 3D model for the organizer. Advantageously, in certain embodiments, by positioning the 3D models for the set of items with respect to the 3D model for an organizer item, an image can be generated that provides an example of how a set of items may be organized using a particular organizer item. The composite 3D image created at the block 816 may be output for presentation to a user as previously described with respect to the block 614 of FIG. 6 or the block 708 of FIG. 7. In some embodiments, the image generator 358 may create a 2D image from the composite 3D image. The generated 2D image may be provided to a user computing device 302 for presentation to a user instead of or in addition to the composite 3D image.

### Example User Interface

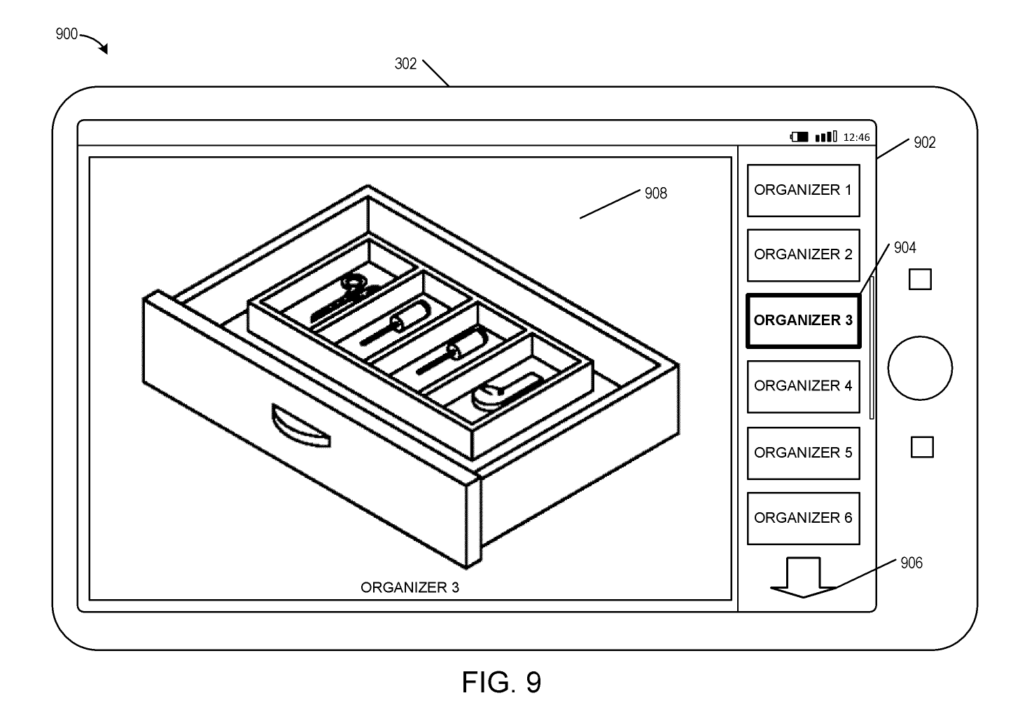

FIG. 9 illustrates an embodiment of a user interface 900 accessed via a user computing device 302 and generated at least in part by the interactive computing system 310 and/or the user computing device 302 for selecting an organizer to preview. The user interface 900 may include a panel 902 for presenting a number of organizers to a user. The panel 902 may present the organizers to the user as images, video, and/or text, depending on the embodiment. The organizers presented to the user via the panel 902 may include catalog images obtained from an electronic catalog. Alternatively, the panel 902 may present thumbnails of preview images that illustrate the use of the organizers with items of the user. The panel 902 may be substituted by a number of different types of user interface elements. For example the panel 902 may be replaced with a ribbon that includes representations of a number of organizers. In the example illustrated in FIG. 9, a user may interact with an arrow 906 to view representations of additional organizer elements.

A user may select one of the organizers from the panel 902 to preview a visual representation of items owned or otherwise possessed by the user organized using the selected organizer item. For example, as illustrated by the bolded text and darker lines surrounding the image, the user in the example of FIG. 9 has selected organizer 3 by interacting with image 904 (e.g., by tapping, double tapping, or moving a cursor over the image 904). In the panel 908, a preview image corresponding to the selected organizer is presented to the user. This preview image illustrates an example of how the selected organizer may be used with respect to items included in an image obtained by the user computing device 302.

In some embodiments, a user may drag, or otherwise interact with, images of items depicted in the panel 908 to another portion of the depicted organizer. Thus, in some such cases, the user may reorganize the items within the preview image illustrated in panel 908 to get a sense of how the user may use the selected organizer. Further, a user may identify some items to be previewed in one organizer and other items to be previewed in another organizer. In some such cases, the two organizers may be previewed together so the user can see how the two organizers may be used in conjunction with each other and the user's items.

Further, in certain embodiments, a user may preview the use of an organizer with items of a particular type that the organizer was not designed or intended for by the manufacturer or designer of the organizer. For instance, a user may select a jewelry box to preview with board game pieces. In some cases, if a threshold number of users select the jewelry box for organizing board game pieces or currency, the jewelry box may be identified as an organizer item to recommend to users who provide images of board game pieces or currency. Thus, in some such cases, an organizer item classified for use with some types of items based on information provided by a manufacturer, designer, or distributor, may be classified for use with additional or alternative types of items based on how users interact with the organizer item.

It should be understood that the user interface 900 illustrated in FIG. 9 is one non-limiting example of how a user may preview an organizer item in a specific context (e.g., a drawer) with respect to items included in an image captured by a user computing device 302. Further, it should be understood that other user interfaces are possible. For example, the panel 908 may occupy the entire display of the user computing device 302 and may illustrate a preview image of an organizer automatically selected by an interactive computing system 310. As another example, the panel 902 may include thumbnails of preview images generated by the image generator 358. Thus, in this example, the image 904 may be a smaller version of the image presented in the panel 908.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A computer-implemented method comprising:
as implemented by one or more computing devices configured with specific computer-executable instructions,
accessing a first image that depicts a plurality of items and a reference marker located within an at least partially bound physical area;
determining a set of organizer items based at least in part on a spatial characteristic of the at least partially bound physical area determined using the reference marker and a characteristic at least one item of the plurality of items;
outputting for presentation to a user, item information for the set of organizer items;
receiving a selection of an organizer item from the set of organizer items;
accessing a three-dimensional (3D) model corresponding to the selected organizer item from an item model repository;
obtaining a 3D model corresponding to a first item from the plurality of items depicted in the first image;
creating a 3D image scene of an example of the organizer item used in conjunction with the first item by positioning the 3D model corresponding to the first item in relation to the 3D model corresponding to the selected organizer item; and
generating a second image based on a rendering of the 3D image scene.

2. The computer-implemented method of claim 1, wherein generating the second image further comprises positioning the rendering of the 3D image scene within an image of the at least partially bound physical area using the depiction of the reference marker in the first image as a reference.

3. The computer-implemented method of claim 1, wherein the rendering of the 3D image comprises a two-dimensional (2D) image.

4. The computer-implemented method of claim 1, wherein obtaining the 3D model corresponding to the first item comprises accessing the 3D model corresponding to the first item from the item model repository.

5. The computer-implemented method of claim 1, wherein obtaining the 3D model corresponding to the first item comprises generating the 3D model corresponding to the first item based at least in part on the depiction of the reference marker in the first image.

6. The computer-implemented method of claim 5, wherein generating the 3D model comprises:
determining a spatial characteristic of the first item based at least in part on the reference marker; and
transforming a portion of the first image depicting the first item into the 3D model of the first item based at least in part on the spatial characteristic of the first item, wherein the portion of the first image is 2D.

7. A system comprising:
an electronic data store configured to at least store specific computer-executable instructions; and
an interactive computing system comprising computer hardware in communication with the electronic data store, the interactive computing system configured to execute the specific compute-executable instructions at least:
access an image depicting a set of items within a storage location;
identify an organizer item capable of being used in conjunction with the set of items depicted in the image, wherein the organizer item is identified from a set of organizer items compatible with the storage location;
select a first item included in the set of items;
access a three-dimensional (3D) model of the organizer item;
obtain a 3D model of the first item; and
generate a composite image by positioning the 3D model of the first item with respect to the 3D model of the organizer item to illustrate an example of using the organizer item in conjunction with the first item.

8. The system of claim 7, wherein positioning the 3D model of the first item with respect to the 3D model of the organizer item further comprises positioning the 3D model of the first item within a portion of the 3D model of the organizer item, the portion of the 3D model of the organizer item representing a compartment of the organizer item configured to store items of an item type corresponding to the first item.

9. The system of claim 7, wherein the interactive computing system is further configured to at least divide the image into a plurality of portions, wherein at least one portion of the plurality of portions comprises a portion of the image corresponding to a second item from the set of items, thereby enabling the second item to be processed separately from the first item.

10. The system of claim 7, wherein the interactive computing system is further configured to at least:
attempt to identify an item type of the first item; and
in response to failing to identify the item type of the first item, create a 3D model of the first item.

11. The system of claim 10, wherein the interactive computing system is further configured to at least generate the 3D model of the first item by:
determining a spatial characteristic of the first item based at least in part on a reference object positioned within the storage location; and
extruding a portion of the image corresponding to the first item based at least in part on the spatial characteristic of the first item to generate the 3D model.

12. The system of claim 7, wherein the interactive computing system is further configured to at least cause output of the composite image for presentation.

13. The system of claim 7, wherein the 3D model of the identified first item is not visible in the composite image, and wherein the interactive computing system is further configured to at least generate a second composite image to make a portion of the 3D model of the organizer item translucent, thereby enabling the 3D model of the identified first item to be viewed in the second composite image.

14. The system of claim 7, wherein the interactive computing system is further configured to at least:
attempt to identify a boundary of the first item included in the set of items;
determine that the first item is occluded in the image by a second item; and
in response to determining that the first item is occluded by a second item, generate an alert that the first item cannot be distinguished from the second item.

15. The system of claim 7, wherein the interactive computing system is further configured to at least modify a view of the composite image corresponding to movement of a user device that captured the image, wherein movement of the user device is detected based at least in part on a comparison of a position of a reference object in the image and a position of the reference object in another image captured by the user device.

16. The system of claim 7, wherein the 3D model of the organizer item comprises a wireframe illustration of the organizer item.

17. The system of claim 7, wherein the image further depicts a reference object relating to a spatial characteristic that is provided to the interactive system at a point in time prior to the interactive computing system accessing the image, and wherein the interactive computing system is further configured to at least identify the set of organizer items compatible with the storage location based at least in part on the image of the reference object.

18. The system of claim 17, wherein the interactive computing system is further configured to at least:
render the composite image as a 2D image to obtain a 2D composite image; and
overlay the 2D composite image on a copy of the image at a position determined by the reference object in depicted in the image, wherein overlaying the 2D composite image on the copy of the image obscures the depiction of the set of items within the storage location.

19. The system of claim 7, wherein, in response to a command from a user, the interactive computing system is further configured to generate an alternative view of the composite image.

20. A computer-readable, non-transitory storage medium storing computer executable instructions that, when executed by one or more computing devices, configure the one or more computing devices to perform operations comprising:
accessing an image comprising an illustration of an item and a reference object;
identifying the item;
identifying a complementary item for the item;
obtaining a three-dimensional (3D) model for the item;
obtaining a 3D model for the complementary item; and
generating a composite image by positioning the 3D model of the item with respect to the 3D model of the complementary item to illustrate use of the item in conjunction with the complementary item, wherein the layout of the 3D model of the item and the 3D model of the complementary item within the composite image is based at least in part on the illustration of the reference object in the image.

21. The computer-readable, non-transitory storage medium of claim 20, wherein obtaining the 3D model for the item further comprises determining a size of the item based on the reference object and extruding a two-dimensional image of the item to create the 3D model for the item.

22. The computer-readable, non-transitory storage medium of claim 20, wherein the composite image further comprises a background image corresponding to a storage location, and wherein the 3D model of the complementary item is positioned relative to the background image bawd at least in part on the illustration of the reference object in the image.
